(19) United States
(12) Patent Application Publication
(10) Pub. No.: US 2018/0188696 A1
(43) Pub. Date: Jul. 5, 2018

(54) MEASUREMENT SYSTEM, TIMEPIECE, MEASUREMENT RESULT DISPLAY METHOD, MEASUREMENT RESULT DISPLAY PROGRAM, MEASURING APPARATUS, MEASUREMENT RESULT INDICATION METHOD, AND MEASUREMENT RESULT INDICATION PROGRAM

(71) Applicant: SEIKO EPSON CORPORATION, Tokyo (JP)

(72) Inventors: Hiroyasu MIMURA, Matsumoto-shi (JP); Atsushi KONDO, Azumino-shi (JP)

(73) Assignee: SEIKO EPSON CORPORATION, Tokyo (JP)

(21) Appl. No.: 15/854,221

(22) Filed: Dec. 26, 2017

(30) Foreign Application Priority Data
Jan. 5, 2017 (JP) 2017-000774

(51) Int. Cl. G04G 21/02; G04C 10/02; G04B 19/04

(52) U.S. Cl. CPC G04G 21/02; G04B 19/04; G04C 10/02

(57) ABSTRACT

A timepiece that can be carried by a user and a measuring apparatus formed separately from the timepiece and being communicable with the timepiece are provided, the measuring apparatus has a measurement unit that measures a predetermined measurement item, a pointer operation information generation unit that generates pointer operation information based on a measurement result by the measurement unit, and a measuring apparatus-side transmitting unit that transmits the generated pointer operation information, and the timepiece has a receiving unit that receives the pointer operation information transmitted from the measuring apparatus, a pointer, and a drive unit that turns the pointer based on the received pointer operation information and allows the pointer to indicate the measurement result.

This application claims priority to JP 2017-000774, filed Jan. 5, 2017, the entire disclosure of which is hereby incorporated by reference in its entirety.

### BACKGROUND

### 1. Technical Field

The present invention relates to a measurement system, timepiece, measurement result display method, measurement result display program, measuring apparatus, measurement result indication method, and measurement result indication program.

### 2. Related Art

In related art, pointer timepieces (so-called analog timepieces) each having a dial face on which scale markings for time display are provided, a plurality of pointers including a hour hand, a minute hand, and a second hand, drive means for driving the plurality of pointers are known. As the pointer timepieces, electronic wristwatches each including a plurality of sensors and displaying detection results by the plurality of sensors using the pointers are known (for example, see Patent Document 1 (JP-A-2013-32919)).

The electronic wristwatch described in Patent Document 1 has a problem that power consumption tends to be higher because of the sensors inside.

On the other hand, a configuration in which the sensors are separated from the timepiece as a sensor unit and the timepiece receives measurement results by the sensor unit and displays the results is considered.

However, the measurement values may differ in scale with respect to each measurement item, and thus, when the received measurement results (measurement values) are displayed by the plurality of pointers, it is necessary for the timepiece to calculate how to move the plurality of pointers. Accordingly, the timepiece has a problem in difficulty of sufficient reduction of the power consumption.

Particularly, a timepiece including a secondary battery charged by electric power generated by a power generation unit such as a solar cell has a problem that the battery is likely to run out when power consumption is larger.

### SUMMARY

An advantage of some aspects of the invention is to provide a measurement system, timepiece, measurement result display method, measurement result display program, measuring apparatus, measurement result indication method, and measurement result indication program that may reduce power consumption.

A measurement system according to an aspect of the invention includes a timepiece that adapted to be carried by a user, and a measuring apparatus provided physically separate from the timepiece and being communicable with the timepiece, the measuring apparatus has a measurement unit that measures a predetermined measurement item, a pointer operation information generation unit that generates pointer operation information based on a measurement result by the measurement unit, and a measuring apparatus-side transmitting unit that transmits the generated pointer operation information, and the timepiece has a timepiece-side receiving unit that receives the pointer operation information transmitted from the measuring apparatus, a pointer, and a drive unit that turns the pointer based on the received pointer operation information and allows the pointer to indicate the measurement result.

According to the aspect of the invention, the measurement result by the measuring apparatus formed separately from the timepiece may be displayed by the pointer of the timepiece, and thereby, the user may intuitively grasp the measurement result. In this regard, the drive unit of the timepiece indicates the measurement result by turning the pointer based on the pointer operation information transmitted from the measuring apparatus and received by the timepiece-side receiving unit. According to the configuration, compared to the case where a measurement value as the measurement result is received from the measuring apparatus, the timepiece calculates the position of the pointer according to the measurement value, and the drive unit of the timepiece turns the pointer to the calculated position, processing of the timepiece may be omitted or simplified. Therefore, power consumption of the timepiece may be reduced, and further, the configuration of the timepiece may be simplified.

Further, even in the case where the measuring apparatus that measures various measurement items is employed in the measurement system according to the aspect of the invention, the timepiece may reliably display the measurement result by the measuring apparatus based on the pointer operation information only by the measuring apparatus transmitting the pointer operation information. Therefore, the timepiece maybe used as a general-purpose display device, and the convenience of the timepiece, i.e., the measurement system may be improved.

In the aspect of the invention, it is preferable that the measuring apparatus-side transmitting unit transmits the pointer operation information based on the measurement results at predetermined intervals, and the pointer operation information generation unit generates the pointer operation information based on a difference between a newly acquired measurement result and a measurement result according to the pointer operation information transmitted immediately before of the measurement results by the measurement unit.

According to the aspect of the invention with this configuration, the pointer operation information is generated based on the difference between the measurement result newly measured by the measurement unit and the measurement result according to the pointer operation information transmitted immediately before (the measurement result on which the pointer operation information is based). Thereby, when the newly measured measurement result is indicated, the amount of movement (amount of turn) of the pointer from the current position may be made smaller. Therefore, power consumption with the movement of the pointer may be further reduced.

In the aspect of the invention, it is preferable that a plurality of the pointers are provided according to a number of digits of a measurement value as the measurement result, and the pointer operation information generation unit generates the pointer operation information based on differences between respective positions of the plurality of pointers indicating the newly acquired measurement result and respective positions of the plurality of pointers indicating the measurement result according to the pointer operation information transmitted immediately before.

Here, when a relatively large numeric value (e.g. a value equal to or more than a thousand) is indicated by a single pointer, higher movement precision of the pointer is required, and further, when a larger change occurs in the measurement value, a relatively long time is required for turning of the pointer. On the other hand, according to the aspect of the invention, the plurality of pointers are provided according to the number of digits of the measurement value as the measurement result, and thereby, the numeric value indicated by each pointer may be made smaller. Therefore, even when the movement precision of the pointer is not higher, the user may reliably read the measurement value, and further, the measurement result may be quickly displayed.

Further, the pointer operation information is generated based on the differences between the positions of the respective pointers indicating the newly acquired measurement result and the positions of the respective pointers indicating the measurement result according to the pointer operation information transmitted immediately before (i.e., the current positions of the respective pointers). According to the configuration, the respective pointers may be individually turned, and thereby, the respective pointers may be efficiently turned. Therefore, power consumption with the movement of the pointers may be further reduced.

In the aspect of the invention, it is preferable that the pointer operation information is information containing a direction of turn and an amount of turn of the pointer, and the drive unit turns the pointer according to the direction of turn and the amount of turn of the pointer contained in the pointer operation information.

Note that, for example, in the case where the drive unit that turns the pointer has a stepping motor, the amount of turn may be the number of steps (number of pulses) supplied to the stepping motor.

According to the aspect of the invention with this configuration, the pointer operation information contains the direction of turn and the amount of turn, and thereby, the pointer may be turned and the measurement result (measurement value) by the measuring apparatus may be reliably displayed only by receiving the pointer operation information and inputting the direction of turn and the amount of turn to the drive unit. In this regard, the pointer operation information contains the direction of turn of the pointer, and thereby, the pointer may be turned in one direction and the other direction and the pointer may be efficiently turned. Therefore, power consumption when the measurement result is indicated by the movement of the pointer may be reliably reduced.

In the aspect of the invention, it is preferable that the timepiece has a power generation unit, a secondary battery that supplies drive power to the timepiece, and a charging unit that charges the secondary battery by electric power generated by the power generation unit.

As the power generation unit, a power generator that generates power by rotation of a rotor may be exemplified in addition to a solar panel (solar cell).

According to the aspect of the invention with this configuration, the secondary battery is charged, and thereby, the timepiece may permanently function.

Here, the voltage of the electric power generated by the power generation unit exemplified as above is not so high. Accordingly, when the power consumption for indicating the measurement result is larger, shortage of the electric power accumulated in the secondary battery may be anticipated. In this case, measures including increase of the capacity of the secondary battery are necessary.

On the other hand, in the aspect of the invention with the configuration described above, the power consumption for indicating the measurement result is reduced, and thereby, the remaining battery of the secondary battery for the timepiece to function may be easily secured and the timepiece may continue to reliably function.

In the aspect of the invention, it is preferable that the timepiece has an input unit that receives an input operation of the user, and a timepiece-side transmitting unit that transmits start information in response to the input operation, the measurement unit is adapted to measure a plurality of measurement items different from one another, and the measuring apparatus has an object changeover part that changes a transmission object item as a measurement item to be transmitted of the pointer operation information of the plurality of measurement items, a measuring apparatus-side receiving unit that receives the start information, and an informing unit that informs the transmission object item when the start information is received.

Note that the measurement unit may have sensors according to the respective plurality of measurement items or may be adapted to measure the plurality of measurement items based on a detection result by a single sensor.

According to the aspect of the invention with this configuration, when the start information transmitted in response to the input operation by the user for the input unit is received by the measuring apparatus-side receiving unit, the transmission object item to be changed by the object switchover unit is informed. Thereby, the user of the timepiece may grasp the measurement item for which the measurement result is indicated by the pointer of the plurality of measurement items that can be measured by the measurement unit. Therefore, the convenience of the measurement system may be improved.

In the aspect of the invention, it is preferable that the informing unit has a plurality of light emitting portions according to the plurality of measurement items, and the measuring apparatus has an informing control part that turns on the light emitting portion according to the transmission object item of the plurality of light emitting portions.

According to the aspect of the invention with this configuration, the lighted light emitting portion is checked, and thereby, the transmission object item may be easily grasped. Therefore, compared to the case where the transmission object item is informed by sound or the like, the transmission object item may be grasped more easily.

In the aspect of the invention, it is preferable that the timepiece has a timer that starts after the input operation is performed, and a pointer control part that stops a movement of the pointer after a timed time by the timer exceeds a predetermined time.

According to the aspect of the invention with this configuration, the turning of the pointer according to the pointer operation information received from the measuring apparatus, i.e., display of the measurement result using the pointer may be after the input operation is performed and before the predetermined time elapses. Therefore, compared to the case where the turning of the pointer is performed over a long period, the power consumption may be reduced.

In the aspect of the invention, it is preferable that the measurement unit measures at least one measurement item of atmospheric pressure, direction, temperature, illuminance, amount of ultraviolet light, radiation dose, acceleration, angular velocity, and position.

Note that the measurement items maybe measured using an atmospheric pressure sensor, geomagnetic sensor, luminance sensor, ultraviolet sensor, radiation sensor, acceleration sensor, angular velocity sensor, and position sensor (GPS sensor or the like).

According to the aspect of the invention with this configuration, the measurement result of at least one of the measurement items is displayed by the pointer, and thereby, the use of the measurement system may be made wider.

A timepiece according to an aspect of the invention includes a pointer, a receiving unit that receives pointer operation information containing an amount of turn of the pointer from outside, and a drive unit that turns the pointer based on the amount of turn contained in the received pointer operation information.

According to the aspect of the invention, the timepiece is combined with the measuring apparatus, and thereby, the same advantages as those of the measurement system may be offered.

A measurement result display method according to an aspect of the invention is a measurement result display method performed by a timepiece having a pointer, including receiving pointer operation information containing an amount of turn of the pointer from outside, and turning the pointer according to the amount of turn contained in the received pointer operation information.

According to the aspect of the invention, the timepiece having the pointer performs the measurement result display method, and thereby, the same advantages as those of the timepiece may be offered.

A measurement result display program according to an aspect of the invention is a measurement result display program executed by a timepiece having a pointer, allowing the timepiece to execute receiving pointer operation information containing an amount of turn of the pointer from outside, and turning the pointer according to the amount of turn contained in the received pointer operation information.

According to the aspect of the invention, the timepiece having the pointer executes the measurement result display program, and thereby, the same advantages as those of the timepiece may be offered.

A measuring apparatus according to an aspect of the invention is a measuring apparatus communicable with a timepiece having a pointer, including a measurement unit that measures a predetermined measurement item, a pointer operation information generation unit that generates pointer operation information containing an amount of turn of the pointer for positioning the pointer in a position according to a measurement result by the measurement unit, and a transmitting unit that transmits the generated pointer operation information to the timepiece.

According to the aspect of the invention, the measuring apparatus is combined with the timepiece, and thereby, the same advantages as those of the measurement system may be offered.

A measurement result indication method according to an aspect of the invention is a measurement result indication method performed by a measuring apparatus communicable with a timepiece having a pointer, including measuring a predetermined measurement item, generating pointer operation information containing an amount of turn of the pointer for positioning the pointer in a position according to a measurement result in the measurement, and transmitting the generated pointer operation information to the timepiece.

According to the aspect of the invention, the measuring apparatus communicable with the timepiece having the pointer performs the measurement result indication method, and thereby, the same advantages as those of the measuring apparatus may be offered.

A measurement result indication program according to an aspect of the invention is a measurement result indication program executed by a measuring apparatus communicable with a timepiece having a pointer, allowing the measuring apparatus to execute measuring a predetermined measurement item, generating pointer operation information containing an amount of turn of the pointer for positioning the pointer in a position according to a measurement result in the measurement, and transmitting the generated pointer operation information to the timepiece.

According to the aspect of the invention, the measuring apparatus communicable with the timepiece having the pointer executes the measurement result indication program, and thereby, the same advantages as those of the measuring apparatus may be offered.

### BRIEF DESCRIPTION OF THE DRAWINGS

The invention will be described with reference to the accompanying drawings, wherein like numbers reference like elements.

FIG. 1 is a schematic diagram showing a configuration of a measurement system according to one embodiment of the invention.

FIG. 2 is a schematic diagram of a timepiece in the embodiment as seen from the front.

FIG. 3 is a block diagram showing an internal configuration of the timepiece in the embodiment.

FIG. 4 is a block diagram showing a configuration of a control unit of the timepiece in the embodiment.

FIG. 5 is a schematic diagram showing an appearance of a measuring apparatus in the embodiment.

FIG. 6 is a block diagram showing a configuration of an apparatus main body of the measuring apparatus in the embodiment.

FIG. 7 is a block diagram showing a configuration of a control unit of the measuring apparatus in the embodiment.

FIG. 8 is a flowchart showing display processing in the embodiment.

### DESCRIPTION OF EXEMPLARY EMBODIMENTS

As below, one embodiment of the invention will be explained with reference to the drawings.

### Schematic Configuration of Measurement System

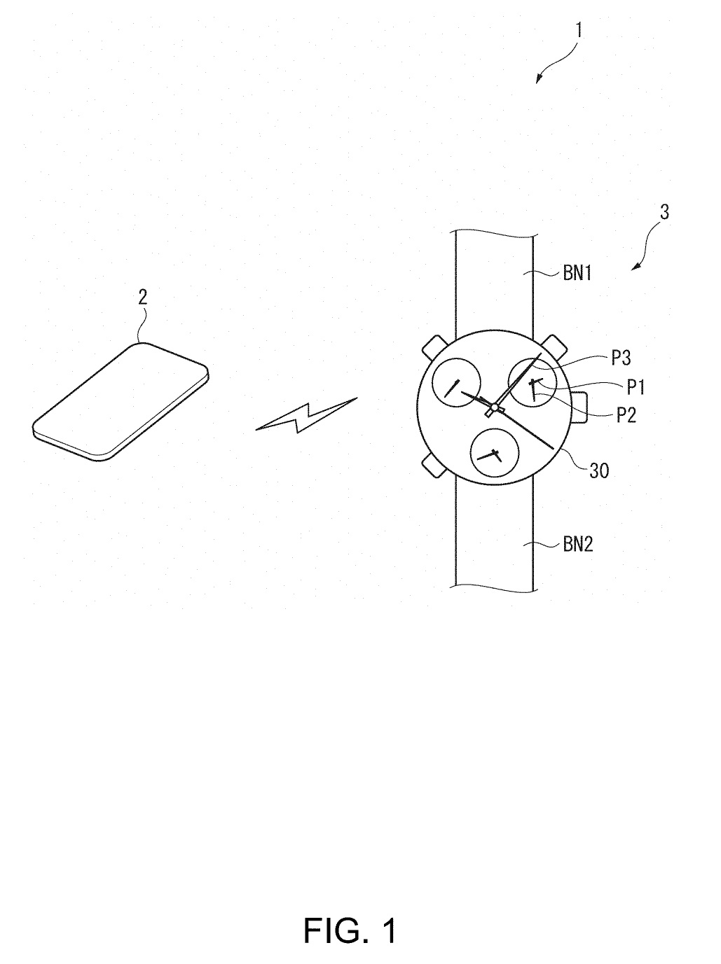

FIG. 1 is a schematic diagram showing a configuration of a measurement system 1 according to the embodiment.

As shown in FIG. 1, the measurement system 1 according to the embodiment includes a measuring apparatus 2 and an analog timepiece 3 adapted to communicate with each other.

In the measurement system 1, as one of the features, the measuring apparatus 2 transmits pointer operation information according to measurement results of a predetermined measurement item to the timepiece 3 and displays the measurement results by the timepiece 3 moving (turning) pointers P1 to P3 based on the received pointer operation information.

As below, regarding the respective configurations of the measurement system 1, the timepiece 3 will be explained first, and then, the measuring apparatus 2 will be explained.

### External Configuration of Watch

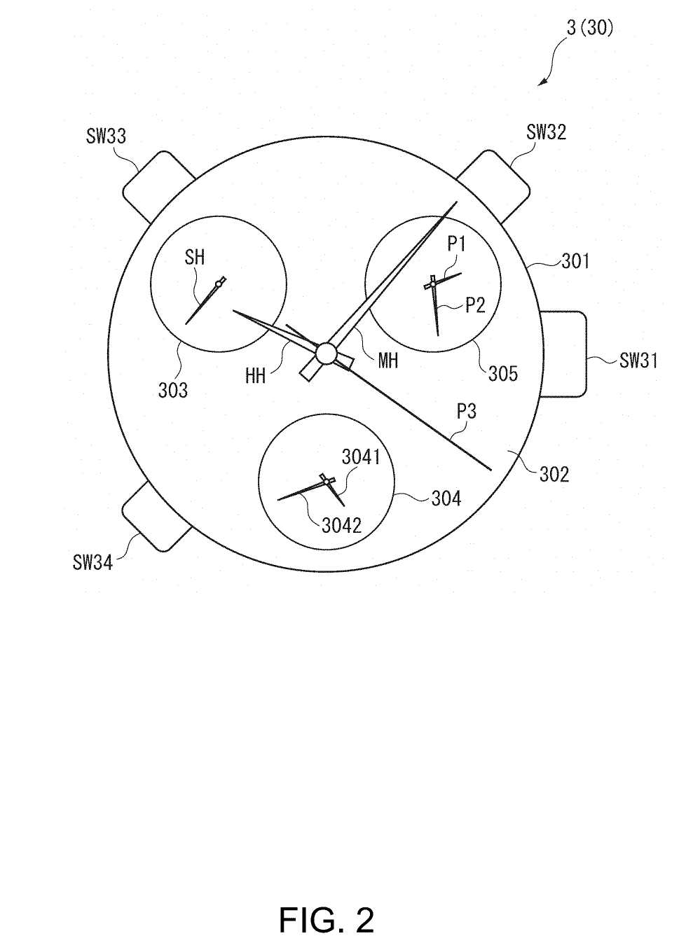

FIG. 2 is a schematic diagram of the timepiece 3 (watch main body 30) as seen from the front.

The timepiece 3 is a wearable apparatus adapted to be carried by a user and worn and used by the user. The timepiece 3 includes the timepiece main body 30 and bands BN1, BN2 for attaching the timepiece main body 30 to the body (e.g. a wrist) of the user.

As shown in FIG. 2, the timepiece main body 30 has a casing 301 in a nearly circular shape in the front view, a dial face 302 in a circular shape provided on the casing 301, an hour hand HH, a minute hand MH, a second hand SH, small windows 303 to 305, the pointers P1 to P3, and switches SW31 to SW34.

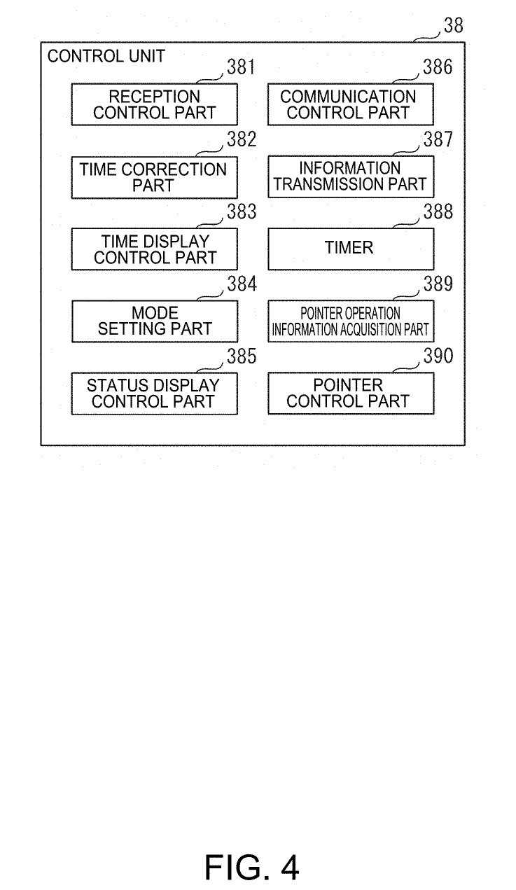

The hour hand HH and the minute hand MH are turnably provided so that the respective turning axes may be coaxial nearly at the center of the dial face 302. Further, the second hand SH is turnably provided in the small window 303 placed nearly in the direction of 10 o'clock on the dial face 302. The turning of these hour hand HH, minute hand MH, and second hand SH is controlled by a time display control unit 383 (see FIG. 4), which will be described later.

The small window 304 is placed nearly in the direction of 6 o'clock on the dial face 302. In the small window 304, a mode display pointer 3041 and a remaining battery display pointer 3042 are turnably placed so that the respective turning axes may be coaxial. The turning of these pointers 3041, 3042 is controlled by a status control unit 385 (see FIG. 4), which will be described later.

The small window 305 is placed nearly in the direction of 2 o'clock on the dial face 302. In the small window 305, the pointers P1, P2 are turnably placed so that the respective turning axes may be coaxial. Of the pointers, the pointer P2 is formed to be longer than the pointer P1.

Further, the pointer P3 is turnably placed on the dial face 302 so that the turning axis may be coaxial with the hour hand HH and the minute hand MH. The turning of these pointers P1 to P3 is controlled by a pointer control unit 390 (see FIG. 4), which will be described later.

Note that the timepiece 3 is adapted to point numeric values of four digits using the above described pointers P1 to P3 when indicating the measurement results by the measuring apparatus 2. For example, of the numeric values of four digits, the first numeric value (the numeric value of the thousands digit) is pointed by the pointer P1, the second numeric value (the numeric value of the hundreds digit) is pointed by the pointer P2, the third and fourth numeric values (the numeric values of the tens and ones digits) are pointed by the pointer P3. The same applies to the case where numeric values after the decimal point are pointed. That is, the pointer P3 points the values from “00” to “99”, the pointers P1, P2 respectively point values from “0” to “1”. The turning of these pointers P1 to P3 will be described later in detail.

The switches SW31 to SW34 form an input unit according to the invention and are provided on the side surface of the casing 301 to project and recede.

The switch SW31 is a switch located in the direction of 3 o'clock on the casing 301 and to be pressed down when communication connection to the measuring apparatus 2 is established.

The switch SW32 is a switch located in the direction of 2 o'clock on the casing 301 and to be pressed down when display of the measurement results by the measuring apparatus 2 is started and ended.

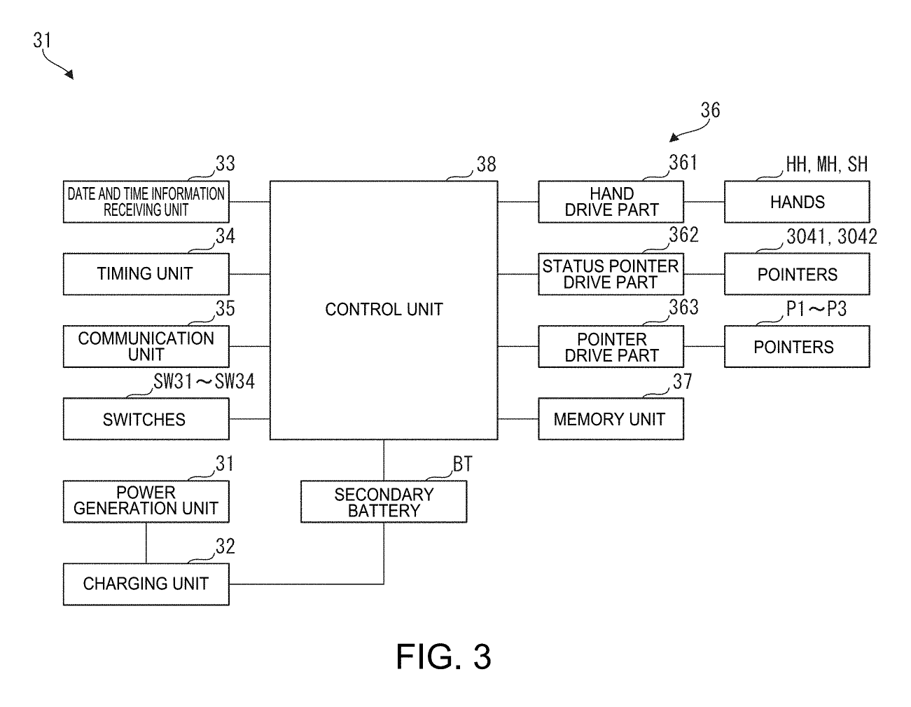

The switch SW33 is a switch located in the direction of 10 o'clock on the casing 301 and to be pressed down when the time is corrected. Specifically, the switch SW33 is the switch pressed down when the time is corrected by a date and time information receiving unit 33 (see FIG. 3), which will be described later, receiving date and time information contained in satellite signals such as GPS (Global Positioning System) signals, standard wave, or the like.

The switch SW34 is a switch to be pressed down when the operation mode of the timepiece 3 is changed. The operation mode will be described later in detail.

When respectively pressed down by the user, these switches SW31 to SW34 output control signals according to the switches to a control unit 38, which will be described later.

### Internal Configuration of Watch

FIG. 3 is a block diagram showing an internal configuration of the timepiece 3.

In addition to the above described configurations, as shown in FIG. 3, the timepiece 3 has a power generation unit 31, a charging unit 32, a secondary battery BT, the date and time information receiving unit 33, a timing unit 34, a communication unit 35, a drive unit 36, a memory unit 37, and the control unit 38.

The power generation unit 31 generates electric power for charging the secondary battery BT. In the embodiment, as the power generation unit 31, a solar panel having a plurality of solar cells (photovoltaic elements) that convert light energy into electrical energy (electric power) is employed. However, the power generation unit 31 is not limited to that. The unit may generate electric power by rotating a rotor.

The charging unit 32 charges the secondary battery BT by the electric power generated in the power generation unit 31.

The secondary battery BT supplies drive power to the timepiece main body 30. Note that the remaining battery of the secondary battery BT is pointed by the remaining battery display pointer 3042.

The date and time information receiving unit 33 receives the date and time information if the control signal when the switch SW33 is pressed is input.

The timing unit 34 times the current time. The current time is corrected by the control unit 38 to be described later based on the date and time information received by the date and time information receiving unit 33.

The communication unit 35 corresponds to a timepiece-side receiving unit, a timepiece-side transmitting unit, and a receiving unit according to the invention, and communicates with the measuring apparatus 2 as an external apparatus under the control of the control unit 38, which will be described later. The communication unit 35 transmits start information for starting display of the measurement results by the measuring apparatus 2 with which communication connection has been established and end information for ending the display to the measuring apparatus 2. Further, the communication unit 35 receives pointer operation information based on the measurement results from the measuring apparatus 2. Then, the communication unit 35 outputs the received pointer operation information to the control unit 38.

The communication unit 35 may be formed using a communication module communicable with an external apparatus in a communication system according to e.g. a near field communication standard such as IEEE 802.15 or communication system according to a communication standard such as IEEE 802.16 or LTE (Long Term Evolution). Note that the former communication system includes Bluetooth (registered trademark).

The drive unit 36 turns (moves) the pointers under the control of the control unit 38, and includes stepping motors provided for the respective pointers in the embodiment. The drive unit 36 has a hand drive part 361, a status pointer drive part 362, and a pointer drive part 363.

The hand drive part 361 turns the hour hand HH, the minute hand MH, and the second hand SH.

The status pointer drive part 362 turns the mode display pointer 3041 and the remaining battery display pointer 3042.

The pointer drive part 363 turns the pointers P1 to P3.

The memory unit 37 includes a nonvolatile memory such as a flash memory, for example, and stores various programs and data necessary for the operation of the timepiece 3. For example, as the program, the memory unit 37 stores a measurement result display program for execution of measurement result display processing by the timepiece 3 (processing including procedures of a measurement result display method according to the invention) for execution of the measurement result indication processing, which will be described later, by the timepiece 3 and the measuring apparatus 2. Further, the memory unit 37 stores connection information when making communication connection to the measuring apparatus 2.

FIG. 4 is a functional block diagram showing a configuration of the control unit 38.

The control unit 38 includes a control circuit such as a CPU (Central Processing Unit), for example, and controls the operation of the entire timepiece 3. For example, the control unit 38 executes processing according to control signals input in response to the pressing down of the switches SW31 to SW34, and further performs correction of the current time, pointer operation processing when the current time is displayed. As shown in FIG. 4, the control unit 38 has a reception control part 381, a time correction part 382, a time display control part 383, a mode setting part 384, the status display control part 385, a communication control part 386, an information transmission part 387, a timer 388, and a pointer operation information acquisition part 389, and a pointer control part 390.

The reception control part 381 allows the date and time information receiving unit 33 to receive date and time information when the control signal is input from the switch SW33. Note that the reception control part 381 may allow the unit to receive date and time information on a regular basis without the input of the control signal, i.e., once a day.

The time correction part 382 corrects the current date and time timed by the timing unit 34 when the date and time information is received by the date and time information receiving unit 33.

The time display control part 383 controls the hand drive part 361 to turn the hour hand HH, the minute hand MH, and the second hand SH according to the current date and time timed by the timing unit 34.

The mode setting part 384 changes the operation mode of the timepiece 3 when the control signal is input from the switch SW34. As the operation modes, an airplane mode for stopping the functions of the date and time information receiving unit 33 and the communication unit 35, a communication mode for communication with an external apparatus including the measuring apparatus 2 may be exemplified.

The status display control part 385 controls the status pointer drive part 362 to displays the status of the timepiece 3 by the pointers 3041, 3042. Specifically, the status display control part 385 displays the current operation mode set by the mode setting part 384 by turning the mode display pointer 3041, and further, displays the remaining battery of the secondary battery BT by turning the remaining battery display pointer 3042. Note that the remaining battery may be detected by detection of the voltage of the drive power supplied from the secondary battery BT.

The communication control part 386 controls the communication by the communication unit 35 with the measuring apparatus 2 as an external apparatus. Specifically, the communication control part 386 establishes the communication by the communication unit 35 with the measuring apparatus 2 and allows the memory unit 37 to store the connection information to the measuring apparatus 2. Then, the communication control part 386 allows the communication unit 35 to communicate with the measuring apparatus 2 based on the connection information and execute transmission and reception of various kinds of information when the communication with the measuring apparatus 2 is necessary.

The information transmission part 387 transmits start information representing the start of the display of the measurement results by the measuring apparatus 2 (the measuring apparatus 2 with which communication connection has been established) to the measuring apparatus 2 by the communication unit 35 when the control signal is input from the switch SW32. Further, the information transmission part 387 transmits end information representing the end of the display of the measurement results to the measuring apparatus 2 by the communication unit 35 when timed time by the timer 388 reaches a predetermined time or when the control signal is input from the switch SW32 again.

The timer 388 times the time after the information transmission part 387 transmits the start signal. Then, if the time exceeds the predetermined time (one minute in the embodiment), the timer 388 allows the information transmission part 387 to transmit the end information. Note that the timed time by the timer 388 is reset after the lapse of the predetermined time, and further, reset when the control signal is input from the switch SW32 again and the information transmission part 387 transmits the end information.

The pointer operation information acquisition part 389 acquires pointer operation information received from the measuring apparatus 2 via the communication unit 35 after the transmission of the start information. The pointer operation information is information representing amounts of turn and directions of turn of the respective pointers P1 to P3 when the measurement results (measurement values) of predetermined measurement items by the measuring apparatus 2 are pointed by the pointers P1 to P3. Specifically, the pointer operation information is information containing the number of steps (number of pulses) input to the stepping motor that turns the pointer P1 and the direction of turn of the pointer P1, the number of steps input to the drive unit that turns the pointer P2 and the direction of turn of the pointer P2, and the number of steps input to the drive unit that turns the pointer P3 and the direction of turn of the pointer P3 of the pointer drive part 363 that turns the pointers P1 to P3.

The pointer control part 390 controls the pointer drive part 363 to move (turn) the pointers P1 to P3 to be placed in initial positions (e.g. positions of “0”) when the information transmission part 387 transmits the start signal. Then, the pointer control part 390 turns the pointers P1 to P3 based on the pointer operation information acquired by the pointer operation information acquisition part 389. Specifically, the pointer control part 390 outputs a pulse signal according to the number of steps and the direction of turn with respect to the pointer P1 contained in the acquired pointer operation information to the motor that turns the pointer P1, outputs a pulse signal according to the number of steps and the direction of turn with respect to the pointer P2 contained in the acquired pointer operation information to the motor that turns the pointer P2, and outputs a pulse signal according to the number of steps and the direction of turn with respect to the pointer P3 contained in the acquired pointer operation information to the motor that turns the pointer P3 of the pointer drive part 363.

As described above, the pointer drive part 363 turns the pointers P1 to P3 according to the input numbers of steps and the directions of turn, and thereby, the measurement results by the measuring apparatus 2 are shown by these pointers P1 to P3.

Note that the measurement results are displayed by the pointers P1 to P3 as described above before the timed time by the timer 388 reaches the predetermined time. Accordingly, the pointer control part 390 stops the pointers P1 to P3 in the current positions when the timed time exceeds the predetermined time. However, not limited to that, the pointer control part 390 may turn the pointers P1 to P3 in the initial positions to show that the measurement result display ends.

Configuration of Measuring Apparatus

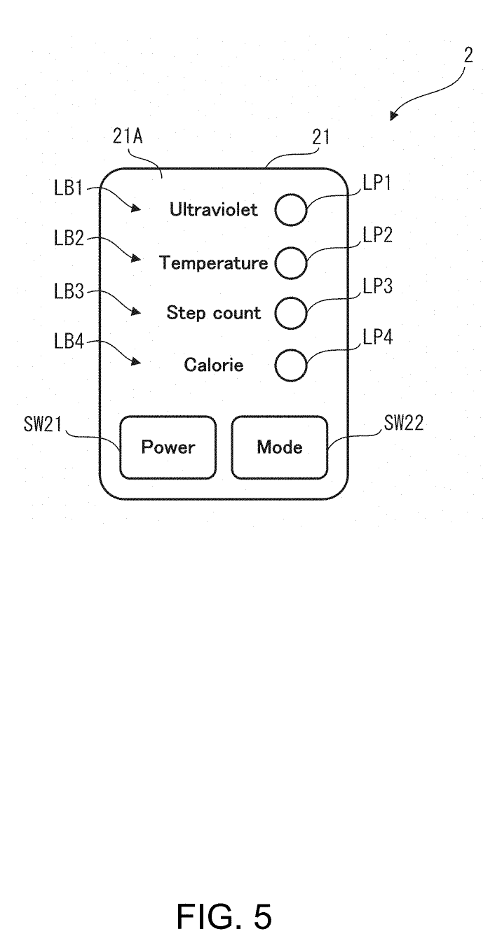

FIG. 5 is a schematic diagram showing an appearance of the measuring apparatus 2.

Next, the measuring apparatus 2 will be explained.

In the embodiment, the measuring apparatus 2 is adapted to be carried by a user as a wearer of the timepiece 3, and measures environments around the measuring apparatus 2 (i.e., the user), and further, measures the movement of the measuring apparatus 2 (i.e., the body motion of the user). The measuring apparatus 2 generates and transmits the pointer operation information for the timepiece 3 to display these measurement results.

As shown in FIG. 5, the measuring apparatus 2 includes a housing 21 formed in a nearly rectangular parallelepiped shape, item labels LB1 to LB4 respectively provided on a front surface 21A of the housing 21, light emitting portions LP1 to LP4, a power switch SW21 and a changeover switch SW22.

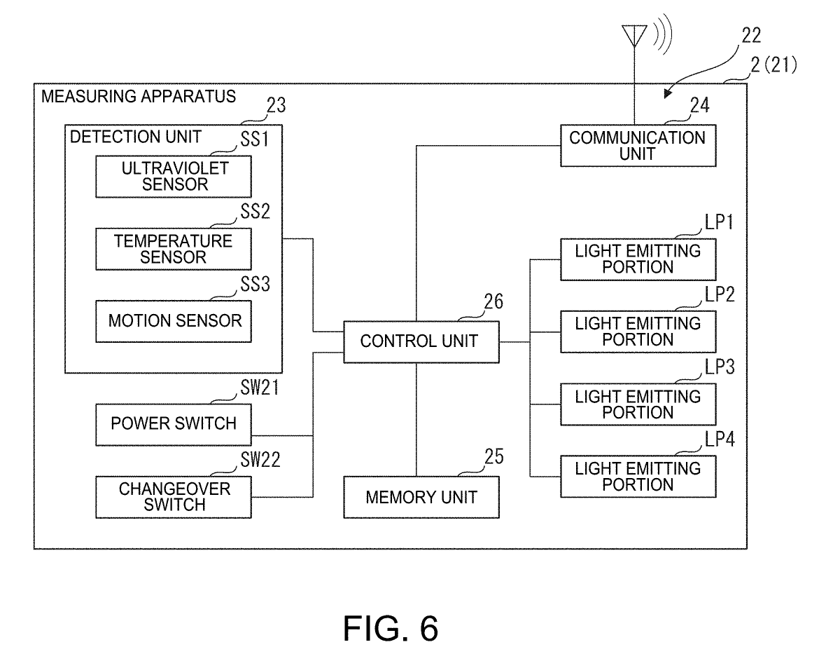

The housing 21 houses an apparatus main body 22 (see FIG. 6), which will be described later, inside.

The item labels LB1 to LB4 are provided according to the number of items that can be measured by the measuring apparatus 2 and respective corresponding names of items are indicated therein. In the embodiment, the measuring apparatus 2 can measure an amount of ultraviolet light, temperature, number of steps, and calories, and the item labels LB1 to LB4 are indicated by “Ultraviolet”, “Temperature”, “Step count”, and “Calorie”.

The light emitting portions LP1 to LP4 form an informing unit according to the invention. These light emitting portions LP1 to LP4 are placed according to the respective item labels LB1 to LB4, lighted under the control of a control unit 26, which will be described later, and show the measurement item that the measuring apparatus 2 transmits the pointer operation information according to the measurement result thereof. In the embodiment, these light emitting portions LP1 to LP4 are formed by LEDs (Light Emitting Diodes).

The power switch SW21 is a switch for turning on/off of the power of the measuring apparatus 2.

The changeover switch SW22 is a switch that outputs a changeover signal for changing the measurement item for which the pointer operation signal is transmitted in response to an input operation of the user.

Configuration of Apparatus Main body

FIG. 6 is a block diagram showing a configuration of the apparatus main body 22.

As shown in FIG. 6, in addition to the above described configuration, the measuring apparatus 2 has the apparatus main body 22 housed within the housing 21. The apparatus main body 22 has a detection unit 23, a communication unit 24, a memory unit 25, and the control unit 26.

### Configuration of Detection Unit

The detection unit 23 forms a measurement unit according to the invention. The detection unit 23 detects information on the user and various kinds of information such as an ambient environment of the measuring apparatus 2. In the embodiment, the detection unit 23 has an ultraviolet sensor SS1, a temperature sensor SS2, and a motion sensor SS3.

The ultraviolet sensor SS1, the temperature sensor SS2, and the motion sensor SS3 detect the amount of ultraviolet light, the temperature, and the motion of the measuring apparatus 2 (i.e., the body motion of the user), respectively. Of them, the motion sensor SS3 includes at least one of an acceleration sensor and an angular velocity sensor that detect an acceleration and an angular velocity acting on the measuring apparatus 2.

Further, the detection unit 23 outputs detection signals representing detection results by these sensors SS1 to SS3.

### Configurations of Communication Unit and Memory Unit

The communication unit 24 corresponds to a measuring apparatus-side transmitting unit, a measuring apparatus-side receiving unit, and a transmitting unit according to the invention. The communication unit 24 communicates with the timepiece 3 as an external apparatus under the control of the control unit 26, receives the start information and end information, and further transmits the pointer operation information generated in the control unit 26 to the timepiece 3. That is, the communication unit 24 corresponds to the measuring apparatus-side transmitting unit and the measuring apparatus-side receiving unit. The communication unit 24 includes a communication module like the communication unit 35.

The memory unit 25 includes a nonvolatile memory such as a flash memory, for example, and stores various programs and data necessary for the operation of the measuring apparatus 2. For example, as the program, the memory unit 25 stores a measurement result indication program for execution of measurement result indication processing (processing including procedures of a measurement result indication method according to the invention) for execution of measurement result indication processing by the measuring apparatus 2 for execution of the measurement result indication processing, which will be described later, by the timepiece 3 and the measuring apparatus 2. In addition, the memory unit 25 stores the measurement results by the respective sensors SS1 to SS3.

### Configuration of Control Unit

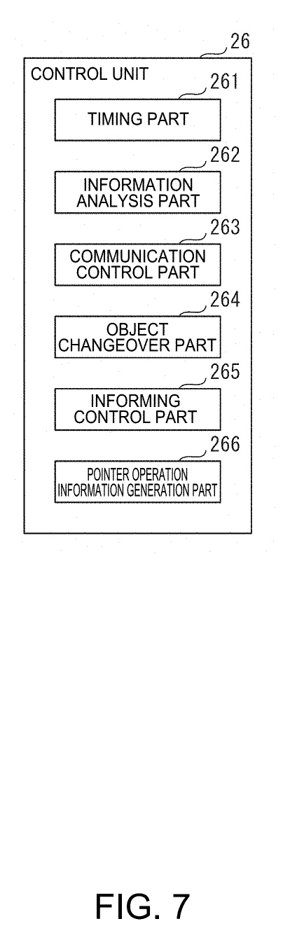

FIG. 7 is a block diagram showing a configuration of the control unit 26.

The control unit 26 includes a control circuit such as a CPU, for example, and controls the operation of the entire measuring apparatus 2. For example, the control unit 26 analyzes the detection signals input from the detection unit 23 and allows the memory unit 25 to store the measurement results with respect to each measurement item. In addition, the control unit 26 generates the pointer operation information based on the measurement results and transmits the pointer operation information to the timepiece 3.

The control unit 26 executes the program stored in the memory unit 25, and thereby, as shown in FIG. 7, functions as a timing part 261, an information analysis part 262, a communication control part 263, an object changeover part 264, an informing control part 265, and a pointer operation information generation part 266.

The timing part 261 times the current date and time.

The information analysis part 262 forms a measurement unit according to the invention with the above described detection unit 23 and analyzes the detection signals input from the respective sensors SS1 to SS3. In the embodiment, the information analysis part 262 calculates the amount of ultraviolet light based on the detection signal input from the ultraviolet sensor SS1, and further calculates the amount of ultraviolet light of the day and the accumulated amount of ultraviolet light based on the current date and time timed by the timing part 261. Further, the information analysis part 262 calculates the ambient temperature of the measuring apparatus 2 based on the detection signal input from the temperature sensor SS2. Furthermore, the information analysis part 262 counts the number of steps of the day and calculates the calorie consumption of the day based on the detection signal input from the motion sensor SS3 and the current time. The information including these measurement values is stored in the memory unit 25.

The communication control part 263 controls the communication with the timepiece 3 as the external apparatus performed via the communication unit 24. For example, when the communication unit 24 communicates with the timepiece 3 via Bluetooth, the communication control part 263 allows the memory unit 25 to store paring information acquired from the timepiece 3 as connection information. Then, the communication control part 263 establishes communication connection with the timepiece 3 based on the connection information, allows the communication unit 24 to receive information (e.g. start information and end information) transmitted from the timepiece 3, and further, transmits various kinds of information (e.g. pointer operation information) to the timepiece 3 by the communication unit 24.

The object changeover part 264 changes the measurement item (transmission object item) corresponding to the pointer operation information transmitted to the timepiece 3 when the changeover signal is input from the changeover switch SW22. In the embodiment, the object changeover part 264 sequentially switches to one of the amount of ultraviolet light, temperature, number of steps, calories that can be respectively measured by the measuring apparatus 2 at each time when the changeover signal is input.

The informing control part 265 turns on the light emitting portion according to the current transmission object item of the light emitting portions LP1 to LP4 when the start information is received from the timepiece 3 by the communication unit 24. Further, the informing control part 265 turns off the light emitting portion being lighted of the light emitting portions LP1 to LP4 when the end information is received by the communication unit 24.

The pointer operation information generation part 266 functions after the start information is received and before the end information is received by the communication unit 24. The pointer operation information generation part 266 generates the pointer operation information based on the measurement result of the transmission object item.

When generating the pointer operation information, the pointer operation information generation part 266 generates the pointer operation information with which the movement of the pointers P1 to P3 is performed most efficiently. In other words, the pointer operation information generation part 266 generates the pointer operation information with which the respective amounts of movement of the pointers P1 to P3 are the minimum.

Specifically, the pointer operation information generation part 266 first specifies the positions of the pointers according to the pointer operation information transmitted immediately before (the current positions of the pointers). Note that, when generating the pointer operation information immediately after the reception of the start information, the pointer operation information generation part 266 specifies the positions of the pointers as positions in which the positions of the pointers P1 to P3 respectively indicate “0”, i.e., the initial positions.

Then, the pointer operation information generation part 266 generates pointer operation information to be newly transmitted based on differences between positions of the respective pointers P1 to P3 indicating the measurement results of the transmission object item that has been newly acquired and the positions of the respective pointers P1 to P3 according to the pointer operation information transmitted immediately before.

For example, when the numeric value of the measurement result (last measurement value) represented by the pointer operation information transmitted immediately before is “1584”, the pointer P1 indicating the first numeric value indicates “1”, the pointer P2 indicating the second numeric value indicates “5”, and the pointers P3 indicating the third and fourth numeric value indicates “84”. Further, when the numeric value of the newly acquired measurement result (new measurement value) is “1640”, the last measurement value is subtracted from the new measurement value with respect to each digit indicated by the pointers P1 to P3 and the differences between the values are acquired. In the differences of this case, the first numeric value is “0”, the second numeric value is “1”, and the third and fourth numeric value is “−44”. Accordingly, the pointer operation information generation part 266 generates the pointer operation information for moving the pointer P2 in the positive direction (clockwise) by “1” and moving the pointer P3 in the negative direction (counterclockwise) by “44” with the position of the pointer P1 unchanged. That is, in this case, given that the numbers of steps for moving the respective pointers P1 to P3 by “1” are “1”, the pointer operation information in which nothing is set for the direction of turn and the number of steps of the pointer P1, “positive direction” and “1” are set for the direction of turn and the number of steps of the pointer P2, and “negative direction” and “44” are set for the direction of turn and the number of steps of the pointer P3 is generated. That is, in the pointer operation information, “0” is set for the pointer P1, “+1” is set for the pointer P2, and “−44” is set for the pointer P3.

Further, for example, when the last measurement value is “4055” and the new measurement value is “5982”, the pointer operation information generation part 266 generates pointer operation information in which “+1” is set for the pointer P1, “−1” is set for the pointer P2, and “+27” is set for the pointer P3.

Thus generated pointer operation information is transmitted to the timepiece 3 by the communication control part 263.

Note that the pointer operation information is transmitted by the communication control part 263 at predetermined time intervals (e.g. every four seconds). The transmission intervals can be adjusted according to the sampling rates of the respective sensors SS1 to SS3 and generation intervals of the pointer operation information by the pointer operation information generation part 266.

### Display Processing of Measurement Results in Measurement System

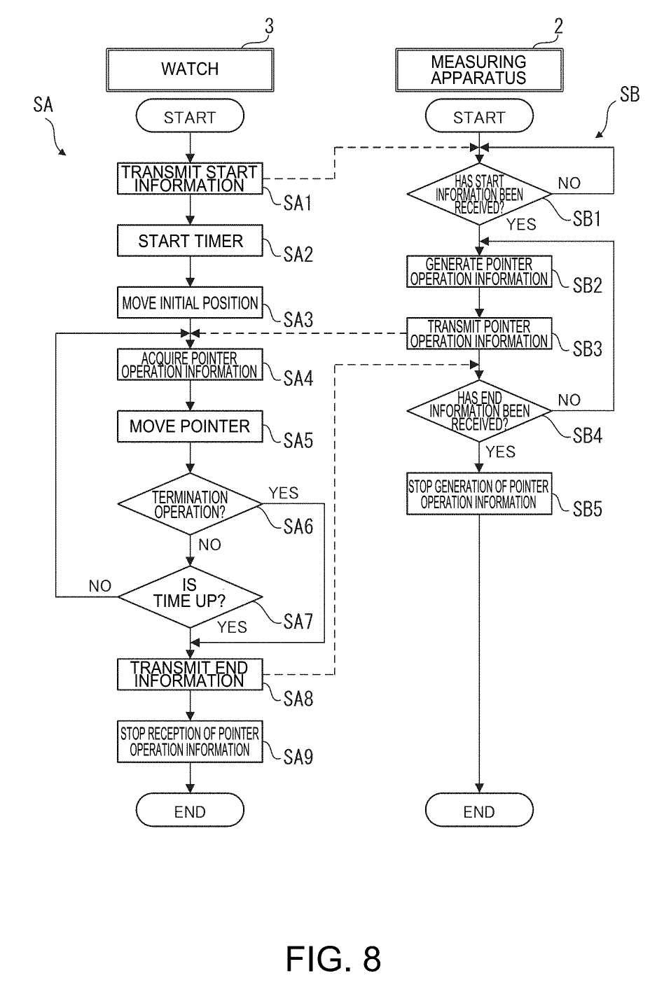

FIG. 8 is a flowchart showing display processing executed by the measuring apparatus 2 and the timepiece 3.

The above described respective measuring apparatus 2 and timepiece 3 execute the display processing shown in FIG. 8, and thereby, the timepiece 3 displays the measurement results by the measuring apparatus 2 using the pointers P1 to P3. The display processing is performed by the control units 26, 38 executing the measurement result indication program and the measurement result display program stored in the memory units 25, 37, respectively and by the timepiece 3 performing measurement result display processing SA and the measuring apparatus 2 performing measurement result indication processing SB.

Note that, in the display processing to be explained, it is assumed that the communication connection between the measuring apparatus 2 and the timepiece 3 has been already established, and further, the detection by the respective sensors SS1 to SS3 and the measurements of the respective measurement items have been already performed in the measuring apparatus 2.

The display processing is started when the user pressed down the switch SW32 provided in the timepiece 3. When the switch SW32 is pressed down, the information transmission part 387 of the timepiece 3 transmits the start information to the measuring apparatus 2 via the communication unit 35 (step SA1).

Then, the timer 388 of the timepiece 3 starts (step SA2) and the pointer control part 390 moves the pointers P1 to P3 to the above described initial positions (step SA3).

Then, the timepiece 3 waits for acquisition of the pointer operation information from the measuring apparatus 2.

On the other hand, the measuring apparatus 2 continues the detection of the respective measurement items by the sensors SS1 to SS3 and the analysis by the information analysis part 262 and determines whether or not the start information has been received from the timepiece 3 by the control unit 26 (step SB1). The determination processing is executed on a regular basis until the start information is received.

In the determination processing at step SB1, if the determination that the start information has been received is made, the pointer operation information generation part 266 generates the above described pointer operation information (step SB2) and the communication control part 263 transmits the generated pointer operation information to the timepiece 3 by the communication unit 24 (step SB3). Note that, even when the above described changeover signal is input from the changeover switch SW22 after the reception of the start information, the pointer operation information generation part 266 generates the pointer operation information in the same manner as that described above.

Then, in the measuring apparatus 2, the control unit 26 determines whether or not the end information has been received from the timepiece 3 (step SB4).

In the determination processing, if the determination that the end information has not been received is made, the control unit 26 returns the processing to step SB2. Thereby, the generation and transmission of the pointer operation information at the above described steps SB2, SB3 are repeatedly executed at predetermined time intervals until the end information is received.

On the other hand, in the determination processing, if the determination that the end information has been received is made, the pointer operation information generation part 266 stops the generation of the pointer operation information and the communication unit 24 also stops the transmission of the pointer operation information (step SB5). Further, at the same time, the informing control part 265 turns off the light emitting portions LP1 to LP4.

Thereby, the measurement result indication processing SB by the measuring apparatus 2 ends. Note that, as will be described later, in the timepiece 3 that transmits the end information, the turning of the pointers P1 to P3 based on the pointer operation information is not performed, and the generation and transmission of the pointer operation information may be continued.

After the step SA3, if the pointer operation information is transmitted from the measuring apparatus 2, the pointer operation information acquisition part 389 of the timepiece 3 acquires the pointer operation information received by the communication unit 35 (step SA4).

Then, the pointer control part 390 moves the pointers P1 to P3 based on the acquired pointer operation information (step SA5). In this regard, the pointer control part 390 outputs a pulse signal according to the pointer operation information (direction of turn and number of steps) on the pointer P1 of the acquired pointer operation information to the stepping motor that turns the pointer Pl, outputs a pulse signal according to the pointer operation information on the pointer P2 to the stepping motor that turns the pointer P2, and outputs a pulse signal according to the pointer operation information on the pointer P3 to the stepping motor that turns the pointer P3. Thereby, the pointer control part 390 may display the measurement results (measurement values) of the above described transmission object items using the pointers P1 to P3 without the need for the complicated calculations for displaying the measurement results by the measuring apparatus 2 using the pointers P1 to P3 and calculations of the directions of turn and amounts of turn of the pointers P1 to P3.

After the step SA5, the control unit 38 of the timepiece 3 determines whether or not a termination operation of the processing of displaying the measurement results by the user has been performed, i.e., whether or not the control signal is input from the switch SW32 (step SA6).

In the determination processing, if the determination that the termination operation has not been performed is made, the control unit 38 moves the processing to step SA7.

On the other hand, in the determination processing, if the determination that the termination operation has been performed is made, the control unit 38 moves the processing to step SA8.

At step SA7, the timer 388 determines whether or not the time after the transmission of the start information has exceeded a predetermined time (step SA7).

In the determination processing, if the determination that the time has not exceeded the predetermined time is made, the control unit 38 returns the processing to step SA4. Thereby, the pointer control part 390 turns the pointers P1 to P3 based on the pointer operation information received again.

On the other hand, in the determination processing, if the determination that the time has exceeded a predetermined time, the timer 388 informs the lapse of the predetermined time. Thereby, the control unit 38 moves the processing to step SA8.

At step SA8, the information transmission part 387 transmits the end information to the measuring apparatus 2 via the communication unit 35 (step SA8). Thereby, the turning of the pointers P1 to P3 by the pointer control part 390 is stopped and the pointers P1 to P3 are stopped in the current positions.

Then, the communication control part 386 stops the reception of the pointer operation information from the measuring apparatus 2 via the communication unit 35 (step SA9) and reduces power consumption.

Here, the measurement result display processing in the timepiece 3 ends.

### Advantages of Embodiment

According to the measurement system 1 of the above described embodiment, the following advantages maybe offered.

In the measurement system 1, the measurement values (measurement results) by the measuring apparatus 2 formed separately from the timepiece 3 may be displayed by the pointers P1 to P3 of the timepiece 3, and the user may intuitively grasp the measurement values. In this regard, the drive unit 36 (pointer drive part 363) of the timepiece 3 indicates the measurement results by turning the pointers P1 to P3 based on the pointer operation information transmitted from the measuring apparatus 2 and received by the date and time information receiving unit 33. According to the configuration, compared to the case where the measurement values are received from the measuring apparatus 2, the control unit 38 of the timepiece 3 calculates the positions of the pointers according to the measurement values, and the drive unit 36 turns the pointers P1 to P3 to the calculated positions, the processing of the timepiece 3 may be omitted or simplified. Therefore, the power consumption of the timepiece 3 may be reduced, and further, the configuration of the timepiece 3 may be simplified.

Further, even in the case where the measuring apparatus 2 that measures various measurement items is employed, the timepiece 3 may reliably display the measurement results by the measuring apparatus 2 based on the pointer operation information only by the measuring apparatus 2 transmitting the pointer operation information. Therefore, the timepiece 3 may be used as a general-purpose display device, and the convenience of the timepiece 3, i.e., the measurement system 1 may be improved.

The pointer operation information generation part 266 generates the pointer operation information based on the differences between the newly detected and analyzed measurement results and the measurement results according to the pointer operation information transmitted immediately before of the measurement results. Then, the communication unit 24 transmits the pointer operation information sequentially generated as above at predetermined intervals. According to the configuration, when the pointers P1 to P3 indicate the newly measured measurement results, the amounts of turn (amounts of movement) of the pointers P1 to P3 from the current positions may be made smaller. Therefore, power consumption with the movement of the pointers P1 to P3 may be further reduced.

A plurality of the pointers P1 to P3 are provided according to the number of digits of the measurement values. The pointer operation information generation part 266 generates the pointer operation information based on the differences between the positions of the respective pointers P1 to P3 indicating the newly acquired measurement results and the positions of the respective pointers P1 to P3 indicating the measurement results according to the pointer operation information transmitted immediately before (the current positions of the respective pointers P1 to P3). According to the configuration, compared to the case where a four-digit numeric value is shown by a single pointer, even when the movement precision of the respective pointers P1 to P3 is not higher, the measurement values may be reliably read, and further, the measurement results may be quickly displayed.

The respective pointers P1 to P3 maybe individually turned according to the pointer operation information generated as above, and thereby, the pointers P1 to P3 may be turned more efficiently. Therefore, power consumption with the movement of the pointers P1 to P3 may be further reduced.

The pointer operation information is information containing the directions of turn and numbers of steps (in other words, the amounts of turn) of the respective pointers P1 to P3. The drive unit 36 (pointer drive part 363) turns the respective pointers P1 to P3 according to the directions of turn and numbers of steps of the pointers P1 to P3 contained in the pointer operation information. According to the configuration, the pointers P1 to P3 may be turned and the measurement results (measurement values) by the measuring apparatus 2 may be reliably and simply displayed only by inputting pulse signals according to the directions of turn and numbers of steps contained in the pointer operation information to the drive unit 36. In this regard, the pointer operation information contains the directions of turn of the respective pointers P1 to P3, and thereby, the respective pointers P1 to P3 may be turned in one direction and the other direction and these pointers P1 to P3 maybe efficiently turned. Therefore, power consumption when the measurement results are indicated by the movement of the pointers P1 to P3 may be reliably reduced.

The timepiece 3 has the power generation unit 31, the secondary battery BT, and the charging unit 32 that charges the secondary battery BT by the electric power generated by the power generation unit 31. According to the configuration, the timepiece 3 may permanently function.

Here, the voltage of the electric power generated by a power generator such as a solar panel forming the power generation unit 31 is not so high. Accordingly, when the power consumption for indicating the measurement results using the pointers P1 to P3 is larger, shortage of the electric power accumulated in the secondary battery may be anticipated. In this case, measures including increase of the capacity of the secondary battery are necessary.

On the other hand, according to the above described configuration, the power consumption for indicating the measurement results is reduced, and the remaining battery of the secondary battery BT for the timepiece 3 to function may be easily secured. Therefore, even when the secondary battery BT having smaller capacity is employed, the timepiece 3 may continue to reliably function.

The timepiece 3 has the switch SW32 as an input part that receives the input operation (press-down operation) by the user and the information transmission part 387 and the communication unit 35 that transmit the start information according to the input operation. Further, the detection unit and the information analysis part 262 are adapted to respectively measure the different plurality of measurement items, and the measuring apparatus 2 has the object changeover part 264 that changes the transmission object item as the measurement item to be transmitted of the pointer operation information of the plurality of measurement items, the communication unit 24 that receives the start information, and the light emitting portions LP1 to LP4 as an informing unit that informs the transmission object item when the start information is received. According to the configuration, the user of the timepiece 3 may grasp the measurement items for which the measurement results are indicated by the pointers P1 to P3 by checking the lighting states of the light emitting portions LP1 to LP4. Therefore, the convenience of the measurement system 1 may be improved.

The measuring apparatus 2 has the plurality of light emitting portions LP1 to LP4 according to the plurality of measurement items as the informing unit, and further has the informing control part 265 that turns on the light emitting portion according to the transmission object item of the plurality of light emitting portions LP1 to LP4. According to the configuration, as described above, the lighted light emitting portion of the plurality of light emitting portions LP1 to LP4 is checked, and thereby, the transmission object item may be grasped. Therefore, compared to the case where the transmission object item is informed by sound or the like, the transmission object item may be grasped more easily.

The timepiece 3 has the timer 388 that starts after the switch SW32 is pressed down and the pointer control part 390 that stops the movement of the pointers P1 to P3 after the timed time by the timer 388 exceeds the predetermined time. According to the configuration, the turning of the pointers P1 to P3 according to the acquired pointer operation information, i.e., display of the measurement results using the pointers P1 to P3 may be after the switch SW32 is pressed down and before the predetermined time lapses. Therefore, compared to the case where the turning of the pointers P1 to P3 is performed over a long period, the power consumption may be reduced.

The detection unit 23 has the sensors SS1 to SS3 that respectively measure the amount of ultraviolet light, temperature (ambient temperature), number of steps, and calories (calorie consumption) as the measurement items. According to the configuration, the measurement results of these measurement items are displayed by the pointers P1 to P3, and thereby, the use of the measurement system 1 may be made wider.

### Modifications of Embodiment

The invention is not limited to the above described embodiment, but includes modifications, improvements, etc. within a range in which the purpose of the invention can be achieved.

In the above described embodiment, the measuring apparatus 2 is adapted to be carried by the user as a wearer of the timepiece 3. However, not limited to that, but the measuring apparatus 2 maybe fixed to a predetermined position. For example, the measuring apparatus 2 may be provided in a building, store, public facility, bicycle, or automobile (including motorcycle). That is, the measuring apparatus 2 may be installed in any object.

In the above described embodiment, the measuring apparatus 2 can measure the amount of ultraviolet light, temperature (ambient temperature), number of steps, and calories. However, the measurement items by the measuring apparatus 2 are not limited to those. For example, the measuring apparatus 2 may be adapted to detect and measure biological information including pulse rate (pulse wave), body temperature, brain wave, electrocardiogram, blood sugar level, and exercise intensity of the user, or adapted to detect and measure motion information including an acceleration and angular velocity and body motion information including a moving velocity and moving distance of the user based on the motion information. Further, the measuring apparatus 2 may be adapted to measure environment information including atmospheric pressure, direction, illuminance, humidity, radiation dose, and current position.

Note that the timepiece may have a measuring unit that measures the above described measurement items.

In the above described embodiment, the drive unit 36 (pointer drive part 363) has the three stepping motors that turn the respective pointers P1 to P3. However, the configuration of the pointer drive part 363 is not limited to the configuration having the stepping motors as long as the part may independently turn the respective pointers P1 to P3. For example, the pointer drive part 363 may have actuators such as piezoelectric elements. In this case, the pointer operation information may contain angles of turn and amounts of turn in place of the numbers of steps, and the pointers P1 to P3 may be operated while whether or not pointer operation according to the angles of turn and amounts of turn is performed is determined using the sensors that detect the amounts of turn of the pointers P1 to P3.

In the above described embodiment, the pointer operation information contains the directions of turn of the respective pointers P1 to P3. However, the information is not limited to that. For example, in the case where the pointers P1 to P3 are turned only in one direction, the pointer operation information does not necessarily contain the directions of turn.

In the above described embodiment, the pointer operation information is generated based on the differences between the newly acquired measurement results and the measurement results according to the pointer operation information transmitted immediately before. Specifically, the pointer operation information is generated based on the differences between the positions of the pointers P1 to P3 indicating the newly acquired measurement results and the positions of the pointers P1 to P3 indicating the measurement results according to the pointer operation information transmitted immediately before (the current positions of the pointers P1 to P3). However, the information is not limited to that. The pointer operation information may contain the amounts of turn of the respective pointers P1 to P3 from predetermined positions (e.g. positions from “0”). In this case, the respective pointers P1 to P3 may be turned to the predetermined positions at each time when the pointer operation information is newly received and the respective pointers P1 to P3 may be turned according to the pointer operation information.

In the above described embodiment, in the timepiece 3, the charging unit 32 charges the secondary battery BT using the electric power generated by the power generation unit 31. However, the unit is not limited to that. The charging unit 32 may charge the secondary battery using electric power supplied from outside. Further, the timepiece 3 may include a primary battery in place of the power generation unit 31, the charging unit 32, and the secondary battery BT.

In the above described embodiment, the timepiece 3 transmits the start information according to the press down of the switch SW32. However, the timepiece is not limited to that. The timepiece 3 may transmit the start information according to an input operation for another input part such as a timepiece stem. Further, the timepiece 3 may constantly receive and acquired the pointer operation information and constantly display the measurement results by the measuring apparatus 2.

On the other hand, the measuring apparatus 2 turns on the light emitting portion according to the transmission object item of the light emitting portions LP1 to LP4 when the start information is received. However, the apparatus is not limited to that. The measuring apparatus 2 may inform the transmission object item by sound. When the apparatus has a display panel such as a liquid crystal panel or organic EL (Electro-Luminescence) panel, the transmission object item may be displayed by the display panel. That is, any configuration may form the transmission object item.

In the above described embodiment, the timepiece 3 has the timer 388 starting after the start information is transmitted, and stops the turning of the pointers P1 to P3 according to the pointer operation information when the timed time by the timer 388 exceeds the predetermined time or when the termination operation of pressing down the switch SW32 is performed by the user. However, the timer 388 is not necessarily provided. Further, the predetermined time maybe adapted to be changed by the user.

In the above described embodiment, the pointer operation information is information for turning the pointers P1 to P3 so that the measurement values as the measurement results may be displayed by the pointers P1 to P3. However, the information is not limited to that. The number of pointers indicating the measurement results is not limited to three, but one, two, four, or more. Or, the hour hand, the minute hand, and the second hand may be used as the pointers according to the invention.

Or, for example, in the case where the measuring apparatus 2 transmits pointer operation information to a timepiece having four pointers, the pointer operation information may be pointer operation information for turning these four pointers so that the measurement results may be displayed by the four pointers.

Further, the pointer operation information generation part 266 may generate pointer operation information according to the number of pointers of a timepiece as a transmission destination of the pointer operation information and the configuration and drive system of the drive unit of the pointers. In this case, when the measuring apparatus and the timepiece establish communication connection with each other, the measuring apparatus may receive and store the connection information containing the information and generate the pointer operation information based on the connection information. According to the configuration, even in a timepiece having a different number of pointers or a timepiece in which the angle of turn of the pointer per one step is different from that of the timepiece 3, the measurement results (measurement values) by the measuring apparatus 2 may be reliably displayed by the pointers of the timepiece.

In the above described embodiment, the pointers Pl, P2 are placed in the small window 305 with the turning axes coaxial with each other, and the pointer P3 is placed with the turning axis coaxial with the hour hand HH and the minute hand MH. However, the layout of the pointers P1 to P3 may be appropriately changed, not limited to that. The layout of the respective pointers, small windows, and switches of the timepiece main body 30 can be appropriately changed. Further, for example, part of the pointers such as the remaining battery display pointer 3042 is not necessarily provided.

In the above described embodiment, the measuring apparatus 2 maybe provided as the sensor unit formed separately from the timepiece 3. The measuring apparatus 2 may have another configuration as long as the apparatus has the measurement unit that measures information on predetermined measurement items, the pointer operation information generation unit that generates the pointer operation information based on the measurement results by the measurement unit, and the transmitting unit that transmits the generated pointer operation information. For example, the measuring apparatus 2 may be a smartphone (multifunctional cell phone). In this case, the measuring apparatus 2 acquires and executes the above described measurement result indication program via download or the like, and thereby, may function similarly to the measuring apparatus 2.

What is claimed is:

1. A measurement system comprising:
a timepiece that adapted to be carried by a user; and
a measuring apparatus provided physically separate from the timepiece and being communicable with the timepiece,
wherein the measurement apparatus includes:
a measurement unit that measures a predetermined measurement item,
a pointer operation information generation unit that generates pointer operation information based on a measurement result by the measurement unit, and
a measuring apparatus-side transmitting unit that transmits the generated pointer operation information, and
wherein the timepiece includes:
a timepiece-side receiving unit that receives the pointer operation information transmitted from the measuring apparatus,
a pointer, and
a drive unit that turns the pointer based on the received pointer operation information and allows the pointer to indicate the measurement result.

2. The measurement system according to claim 1,
wherein the measuring apparatus-side transmitting unit transmits the pointer operation information based on the measurement results at predetermined intervals, and
wherein the pointer operation information generation unit generates the pointer operation information based on a difference between a newly acquired measurement result and a measurement result according to the pointer operation information transmitted immediately before of the measurement results by the measurement unit.

3. The measurement system according to claim 2, wherein the pointer includes a plurality of the pointers that are provided according to a number of digits of a measurement value as the measurement result, and
the pointer operation information generation unit generates the pointer operation information based on differences between respective positions of the plurality of pointers indicating the newly acquired measurement result and respective positions of the plurality of pointers indicating the measurement result according to the pointer operation information transmitted immediately before.

4. The measurement system according to claim 1, wherein the pointer operation information is information containing a direction of turn and an amount of turn of the pointer, and the drive unit turns the pointer according to the direction of turn and the amount of turn of the pointer contained in the pointer operation information.

5. The measurement system according to claim 1, wherein the timepiece further comprises:
a power generation unit,
a secondary battery that supplies drive power to the timepiece, and
a charging unit that charges the secondary battery by electric power generated by the power generation unit.

6. The measurement system according to claim 1, wherein the timepiece further comprises:
an input unit that receives an input operation of the user, and
a timepiece-side transmitting unit that transmits start information in response to the input operation,
the measurement unit is adapted to measure a plurality of measurement items different from one another,
wherein the measuring apparatus further comprises:
an object changeover part that changes a transmission object item as a measurement item to be transmitted of the pointer operation information of the plurality of measurement items,
a measuring apparatus-side receiving unit that receives the start information, and
an informing unit that informs the transmission object item when the start information is received.

7. The measurement system according to claim 6, wherein the informing unit includes a plurality of light emitting portions corresponding to the plurality of measurement items, and
the measuring apparatus has an informing control part that turns on at least one of the light emitting portions according to the transmission object item of the plurality of light emitting portions.

8. The measurement system according to claim 6, wherein the timepiece further comprises:
a timer that starts after the input operation is performed, and
a pointer control part that stops a movement of the pointer after a time that is timed by the timer exceeds a predetermined time.

9. The measurement system according to claim. 1, wherein the measurement unit measures at least one measurement item of atmospheric pressure, direction, temperature, illuminance, amount of ultraviolet light, radiation dose, acceleration, angular velocity, and position.

10. A measuring apparatus communicable with a timepiece having a pointer, comprising:
a measurement unit that measures a predetermined measurement item,
a pointer operation information generation unit that generates pointer operation information containing an amount of turn of the pointer for positioning the pointer in a position according to a measurement result by the measurement unit, and
a transmitting unit that transmits the generated pointer operation information to the timepiece, the measuring apparatus being physically separately provided from the timepiece.

11. A measurement result indication method performed by a measuring apparatus communicable with a timepiece having a pointer, comprising:
measuring a predetermined measurement item,
generating pointer operation information containing an amount of turn of the pointer for positioning the pointer in a position according to a measurement result in the measurement, and
transmitting the generated pointer operation information to the timepiece, the measuring apparatus being physically separately provided from the timepiece.

12. A timepiece apparatus comprising:
a timepiece; and
a measurement apparatus,
wherein the timepiece comprises:
a face having at least one pointer; and
a communication unit provided to receive input from the measurement apparatus,
wherein the measurement apparatus comprises:
a transmitting unit provided to transmit information to the measurement apparatus,
wherein the measurement apparatus and timepiece are provided as separate, distinct components, and
wherein the timepiece includes a control unit that controls movement of the at least one pointer in response to received information transmitted from the measurement apparatus.

13. The timepiece apparatus according to claim 12, wherein the measurement apparatus includes a changeover switch provided as an input unit whereby a user of the measurement apparatus is able to select a type of measurement data as the information to be provided to the timepiece.

14. The timepiece apparatus according to claim 12, wherein the measurement apparatus includes a plurality of sensors including at least an atmospheric pressure sensor, geomagnetic sensor, luminance sensor, ultraviolet sensor, radiation sensor, acceleration sensor, angular velocity sensor, and position sensor.
